(19) United States
(12) Patent Application Publication
(10) Pub. No.: US 2008/0232481 A1
(43) Pub. Date: Sep. 25, 2008

(54) METHOD AND APPARATUS FOR CHANNEL INTERPOLATION IN A TDS-OFDM SYSTEM OR DVB T/H SYSTEM

(75) Inventor: Qin Liu, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/687,689

(22) Filed: Mar. 19, 2007

(51) Int. Cl. H04L 27/28

(52) U.S. Cl. 375/260; 375/E07.002

(57) ABSTRACT

In an OFDM system, a method for interpolating comprising the steps of: subdividing at least one frame among a plurality of frames into segments; and using at least two known quantities to interpolate a corresponding estimate.

### FIELD OF THE INVENTION

The present invention relates generally to channel interpolation, more specifically the present invention relates to channel interpolation in TDS-OFDM system or alternatively in conventional OFDM system.

### BACKGROUND

In mobile reception of TDS-OFDM or conventional OFDM system, channel is characterized as fast fading and time-varying. Traditional channel estimation gives us only estimation of the channel on a specific interval. More specifically, in TDS-OFDM system, PN-based channel estimation (CE) gives us the CE merely on the pseudo noise (PN) part instead of the data part. In traditional OFDM system with pilot-aided CE, typically only a single CE on the whole frame is achievable. Mobile reception calls for differentiated CE for different portions of the data.

Therefore, channel estimations in sub-frame level are desirable.

### SUMMARY OF THE INVENTION

In an OFDM system, channel estimation on a sub-frame level is achieved using interpolation method.

In a TDS-OFDM system, channel estimation on a sub-frame level is achieved using interpolation method.

In an OFDM system, a method for interpolating comprising the steps of subdividing at least one frame among a plurality of frames into segments; and using at least two known quantities to interpolate a corresponding estimate.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example TDS-OFDM frame structure and corresponding channel estimation in accordance with some embodiments of the invention.

FIG. 2 is an example of linear interpolation associated with FIG. 1.

FIG. 3 is an example OFDM frame structure and corresponding channel estimation in accordance with some embodiments of the invention

FIG. 4 is an example is an example of linear interpolation associated with FIG. 3.

FIG. 5 is an example of a receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to channel estimation on a sub-frame level using known interpolation methods. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of channel estimation on a sub-frame level using known interpolation methods described herein. The non-processor circuits may include, but are not limited to, a radio receiver, a radio transmitter, signal drivers, clock circuits, power source circuits, and user input devices. As such, these functions may be interpreted as steps of a method to perform channel estimation on a sub-frame level using known interpolation methods. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

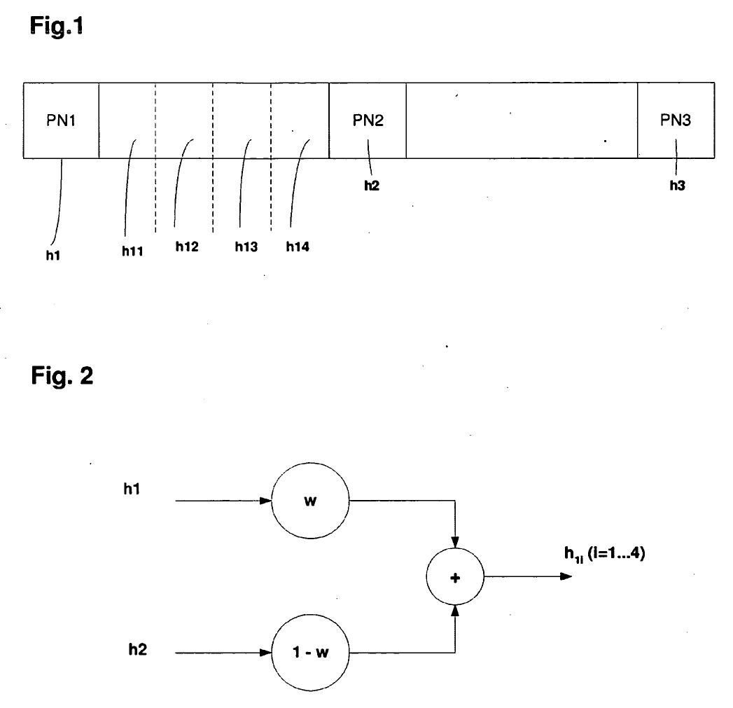

Referring to FIGS. 1-2, a channel interpolation for a TDS-OFDM system is shown. Pseudo noise (PN) sequences serve as guard intervals (GI) in the TDS-OFDM. PNs carry known channel information regarding channel characteristics. Using adjacent PNs such as PN1 and PN2, channel characteristics of the frame or symbol interposed between the PN can be computed using interpolation methods such as linear interpolation. The interposed frame is subdivided into four (4) segments, i.e. h₁₁, h₁₂, h₁₃, and h₁₄. Note that the subdivision is not limit to four segments. Other natural numbers greater than or equal to two (2), such as 2, 6, 8, etc are contemplated by the present invention as well.

A weight ω is associated with the known h1 and therefore h2 (1-ω) as well. A set of weight values associated with h₁₁, h₁₂, h₁₃, and h₁₄ can be achieved as shown in Table 1.

TABLE 1

| | w | 1 − w |
|---|---|---|
| h₁₁ | 0.750 | 0.250 |
| h₁₂ | 0.625 | 0.375 |
| h₁₃ | 0.375 | 0.625 |
| h₁₄ | 0.250 | 0.750 |

More generally, in any OFDM system, the GIs may not provide channel information. Therefore, the adjacent frames or symbols are used for channel interpolation of an interposed frame.

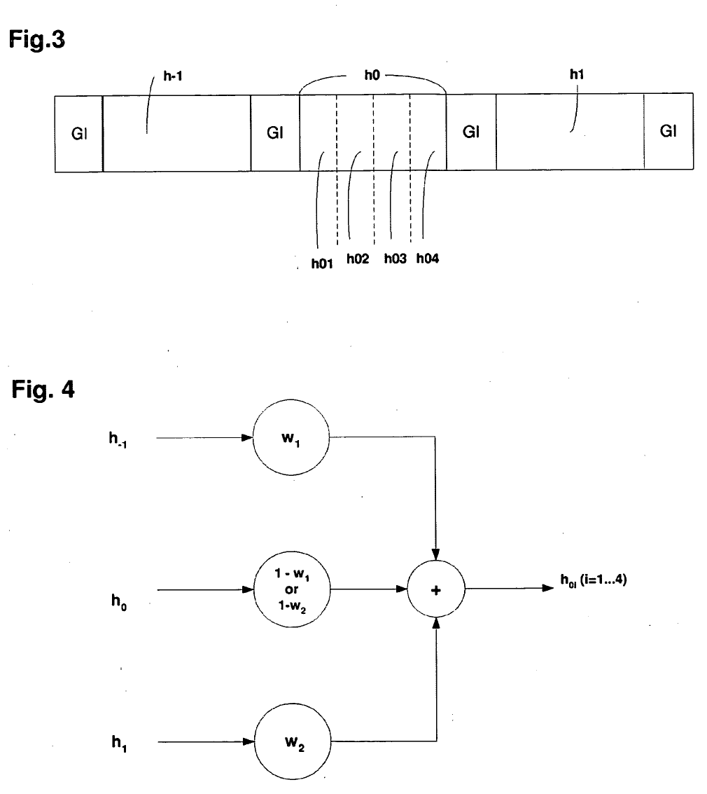

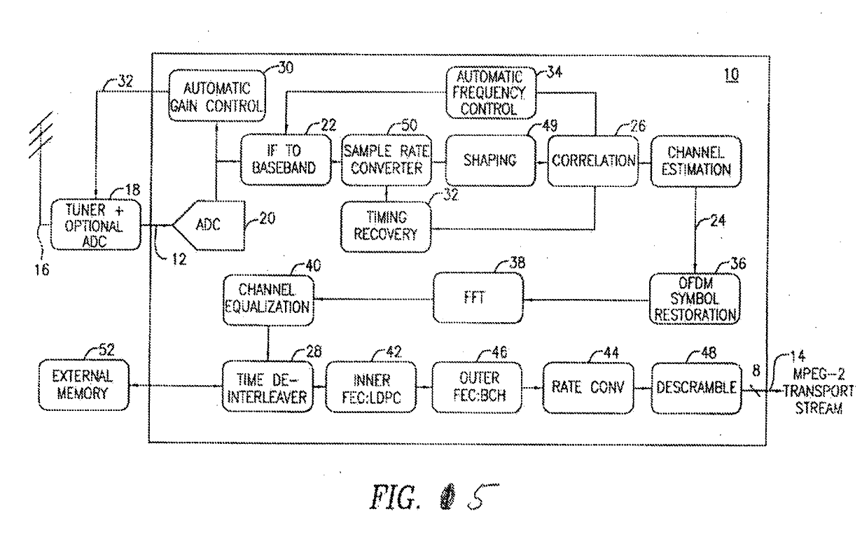

Referring to FIGS. 3-4, a set of OFDM frames with GI is shown. It is assumed that the GIs cannot estimate usable channel information. Therefore, the neighboring frames that do provide usable channel information are used for interpolating a channel estimation. Channel information includes information carried by pilot signals associated with their respective frames. For example, frame h-1 can have a weight ω1 associated therewith, and frame h1 can have a weight ω2 associated therewith. The result weights for interpolation are shown in Table 2.

TABLE 2

| | w₁ | w₂ |
|---|---|---|
| h₀₁ | 0.375 | 0 |
| h₀₂ | 0.250 | 0 |
| h₀₃ | 0 | 0.250 |
| h₀₄ | 0 | 0.375 |

The GI used is not limited to adjacent ones such as PN1 and PN2. Non-adjacent GIs may be chosen and used as well. However, the adjacent GIs are most reflective of the channel characteristics for the weighted estimates hᵢⱼ because of their proximity thereto. When non-adjacent GIs and adjacent GIs are together used, non-linear weighting involving more than two GIs is contemplated by the present invention as well. Further, h₋₁ and h₁ may be further subdivided for a more accurate estimation.

Referring to FIG. 5, a receiver suitable for the present invention that is a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques to reproduce the finite set of discrete messages sent by the transmitter.

The block diagram of FIG. 1 illustrates the signals and key processing steps of the receiver 10. It is assumed that the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF (intermediate frequency) or zero-IF signals 12. The low-IF or zero-IF signals 12 are provided to the receiver 10 as analog signals or as digital signals (through an optional analog-to-digital converter 20).

In the receiver 10, the IF signals are converted to base-band signals 22. TDS-OFDM demodulation is then performed according to the parameters of the LDPC (low-density parity-check) based TDS-OFDM modulation scheme. The output of the channel estimation 24 and correlation block 26 is sent to a time de-interleaver 28 and then to the forward error correction (FEC) block. The output signal 14 of the receiver 10 is a parallel or serial MPEG-2 transport stream including valid data, synchronization and clock signals. The configuration parameters of the receiver 10 can be detected or automatically programmed, or manually set. The main configurable parameters for the receiver 10 include: (1) Sub carrier modulation type including: QPSK, 16QAM, 64QAM; (2) FEC rate including: 0.4, 0.6 and 0.8; (3) Guard interval having: 420 or 945 symbols; (4) Time de-interleaver mode including three modes respectively having: 0, 240 or 720 symbols; (5) Control frames detection; and (6) Channel bandwidth including: 6, 7, or 8 MHz.

The functional blocks of the receiver 10 are described as follows.

Automatic gain control (AGC) block 30 compares the input digitized signal strength with a reference. The difference is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computes the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: a coarse stage and a fine stage. Since the transmitted signal is square root raised cosine filtered, the received signal will be applied with the same function. It is known that signals in a TDS-OFDM system include a PN sequence preceding the IDFT symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a fixed point FFT such as a 3780 point FFT. Channel equalization 40 is carried out from the FFT 38 transformed data based on the frequency response of the channel. De-rotated data and the channel state information are sent to FEC for further processing.

In the TDS-OFDM receiver 10, the time-deinterleaver 28 is used to increase the resilience to spurious noise. The time-deinterleaver 28 is a convolutional de-interleaver which needs a memory with size B*(B−1)*M/2, where B is the number of the branch, and M is the depth. For the TDS-OFDM receiver 10 of the present embodiment, there are three modes of time-deinterleavering. For mode 1 B=52, M=48, mode 2 B=52, M=240, and for mode 3, B=52, M=720.

The LDPC decoder 42 is a soft-decision iterative decoder for decoding, for example, a Quasi-Cyclic Low Density Parity Check (QC-LDPC) code provided by a transmitter (not shown). LDPC decoder 42 is configured to decode at 3 different rates (i.e. rate 0.4, rate 0.6 and rate 0.8) of QC_LDPC codes by sharing the same piece of hardware. The iteration process is either stopped when it reaches the specified maximum iteration number (full iteration), or when the detected error is free during error detecting and correcting process (partial iteration).

The TDS-OFDM modulation/demodulation system is a multi-rated system based on multiple modulation schemes (e.g. QPSK, 16QAM, 64QAM), and multiple coding rates (0.4, 0,6, and 0.8), where QPSK stands for Quad Phase Shift Keying and QAM stands for Quadrature Amplitude Modulation. The output of BCH decoder 46 is bit by bit. According to different modulation schemes and coding rates, the rate conversion block 44 combines the bit output of BCH decoder 46 to bytes, and adjusts the speed of byte output clock to make the receiver 10's MPEG packets outputs evenly distributed during the whole demodulation/decoding process.

The BCH decoder 46 is designed to decode codes such as BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverted information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using the estimated channel estimation previously obtained, the OFDM symbol is equalized and passed to the FEC decoder.

At the FEC decoder, the time-deinterleaver block 28 performs a deconvolution of the transmitted symbol sequence and passes the 3744 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An external memory 52 coupled to the receiver 10 provides memory thereto on a predetermined or as needed basis. It is noted that alternatively the 36 TPS symbols can be removed before time-deinterleaver 28. In an embodiment, the 36 TPS symbols should be removed before processed by time-deinterleaver. The number of symbols in each frame should be multiple of 52 (parameter B) for easy frame synchronization. The number 3744 is the multiple of 52, not 3780.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In an OFDM system, a method for interpolating comprising the steps of:
subdividing at least one frame among a plurality of frames into segments; and
using at least two known quantities to interpolate a corresponding estimate.

2. The method of claim 1 further comprising the step of associating a weight with a subdivision.

3. The method of claim 1, wherein the at least two known quantities are associated with guard intervals.

4. The method of claim 1, wherein the at least two known quantities are associated with neighboring symbols.

5. The method of claim 1, wherein the OFDM system comprises TDS-OFDM system.

6. The method of claim 1, wherein the subdivision comprises dividing a frame into equal length segments.

7. The method of claim 1, wherein the subdivision comprises dividing a frame into four or eight segments.

8. A receiver incorporating the method of claim 1.
